(19) United States
(12) Patent Application Publication
(10) Pub. No.: US 2024/0349215 A1
(43) Pub. Date: Oct. 17, 2024

(54) PERFORMING PROPAGATION DELAY COMPENSATION

(71) Applicant: InterDigital Patent Holdings, Inc., Wilmington, DE (US)

(72) Inventors: J. Patrick Tooher, Montreal (CA); Dylan Watts, Montreal (CA); Faris Alfarhan, Montreal (CA); Paul Marinier, Brossard (CA); Aata El Hamss, Laval (CA)

(73) Assignee: InterDigital Patent Holdings, Inc., Wilmington, DE (US)

(21) Appl. No.: 18/294,876

(22) PCT Filed: Aug. 2, 2022
(86) PCT No.: PCT/US2022/039153

§ 371 Date: Feb. 2, 2024

Related U.S. Application Data
(60) Provisional application No. 63/228,920, filed on Aug. 3, 2021.
(60) Provisional application No. 63/249,338, filed on Sep. 28, 2021.

(51) Int. Cl. H04W 56/00; H04L 1/1812; H04W 36/00; H04W 74/0833; H04W 76/28

(52) U.S. Cl. CPC H04W 56/0045; H04L 1/1812; H04W 36/0058; H04W 74/0833; H04W 76/28

(57) ABSTRACT

Systems, methods, and instrumentalities are described herein for performing propagation delay compensation. For example, a Wireless Transmit/Receive Unit (WTRU) may be configured with the resources and signals to perform a Propagation Delay (RD) procedure, or a Propagation Delay Information Exchange (PDIE), or a Propagation Delay Compensation (PDC). The WTRU may receive configuration that may identify a reference signal (RS) pair for a path. The WTRU may determine that a trigger condition is satisfied for a path. The trigger condition being satisfied may trigger the WTRU to perform a PDIE. The WTRU may determine a propagation delay (RD) for a path. If the determined RD meets a threshold for the path, the WTRU may apply a PDC to an uplink (UL) transmission that uses the path.

### CROSS-REFERENCE TO RELATED APPLICATIONS

This application claims the benefit of Provisional U.S. Patent Application No. 63/228,920, filed Aug. 3, 2021, and Provisional U.S. Patent Application No. 63/249,338, filed Sep. 28, 2021, the disclosures of which are incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for performing propagation delay compensation. For example, a Wireless Transmit/Receive Unit (WTRU) may be configured with the resources and signals to perform a Propagation Delay (PD) procedure, a Propagation Delay Information Exchange (PDIE), or a Propagation Delay Compensation (PDC).

The WTRU may receive configuration information. The configuration information may identify a reference signal (RS) pair for a path (e.g., a RS pair for each path of a number of path(s)). A path (e.g., each path of a number of path(s)) may be associated with at least one of: a bandwidth part (BWP), a carrier, a transmission/reception point (TRP), a cell, a beam, a TCI state, a transmission path, or a link type. RS pair(s) may be determined a function of QCL information, the TCI state, or a spatial relationship between RSs (e.g., two RSs).

The WTRU may determine that a trigger condition is satisfied for a path (e.g., of a number of path(s)). The trigger condition being satisfied may trigger the WTRU to perform a PDIE (e.g., or to determine the next behavior in a PDIE). In examples, the trigger condition being satisfied for the path may be associated with at least one of: a parameter of a path (e.g., of a number of path(s)) being changed, a PDC validity timer expiring, a PDC failure occurring, a measurement value, a random access (RA) procedure, a bandwidth part (BWP) or SCS change, a reception of a signal associated with a PDIE, an uplink (UL) listen-before-talk (LBT) failure detection; beam switching; beam failure detection; an UL transmission type or an UL transmission priority; a location and speed of the WTRU; a cross-layer indication; a request from the WTRU; radio link failure (RLF); Hybrid Automatic Repeat Request (HARQ) ACK feedback; or a transmission of a RS.

The WTRU may receive a downlink (DL) RS for a path (e.g., for each path of a number of path(s)) and transmit a UL RS for a path (e.g., for each path of a number of path(s)). A DL RS and a UL RS (e.g., each DL RS and UL RS) may be associated with a RS pair for a path (e.g., a RS pair for each path of a number of path(s)). The WTRU may receive (e.g., from a gNB) a Rx-Tx time difference value for a path (e.g., for each path of a number of path(s)). The Rx-Tx time difference value may be associated with a Rx-Tx time different measurement report. The Rx-Tx time difference measurement report may include an index for a RS pair on which a time measurement is performed. In examples, the WTRU may perform measurements on a neighboring cell and measurement reporting associated with (e.g., as a function of) a Rx-Tx time difference value for a path (e.g., for each path of a number of path(s)).

The WTRU may determine a propagation delay (PD) for a path (e.g., of a number of path(s)). The PD may be determined based on at least: a timing of a received DL RS, a timing of a transmitted UL RS, and a received Rx-Tx time difference value. If the determined PD meets a threshold for the path (e.g., of a number of path(s)), the WTRU may apply a PDC to an UL transmission that uses the path (e.g., of a number of path(s)). The PDC may be based on the determined PD. In examples, the PDC applied to the UL transmission may be associated with a DRX cycle length or a DRX configuration. In examples, the determined PD may meet the threshold for the path if a PD value is above or below a threshold value. In examples, the PDC may include a first PDC value. The WTRU may determine the validity of the first PDC value based on if: a second PDC value is not received or calculated, the WTRU remains connected to the same TRP, or the WTRU remains within an area (e.g., the WTRU remains stationary or remains within a geo-fenced location).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a control-to-control scenario.

FIG. 3 illustrates an example of a smart-grid scenario.

FIG. 4 illustrates an example of a PDIE procedure to enable WTRU-based PDC.

FIG. 5 illustrates an example of a PDIE procedure to enable gNB-based pre-compensation.

FIG. 6 illustrates an example of a WTRU performing a PD procedure.

### DETAILED DESCRIPTION

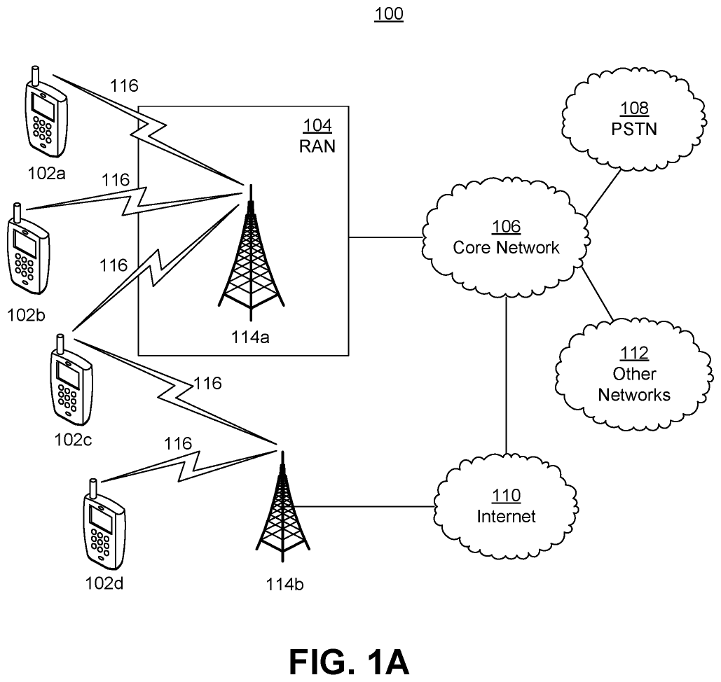

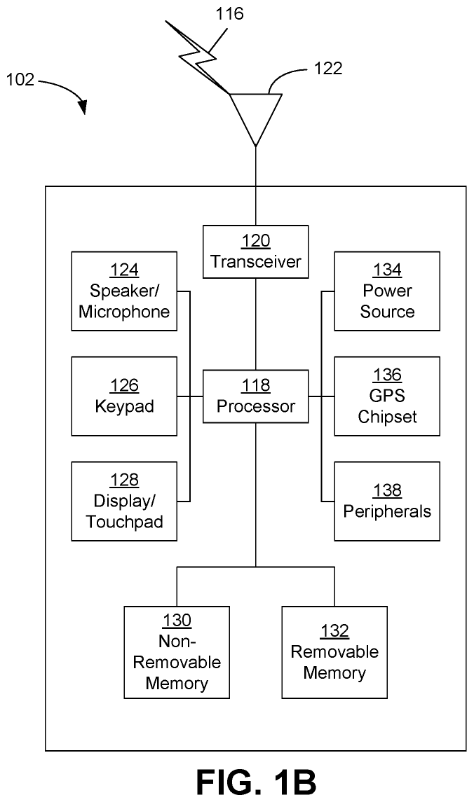

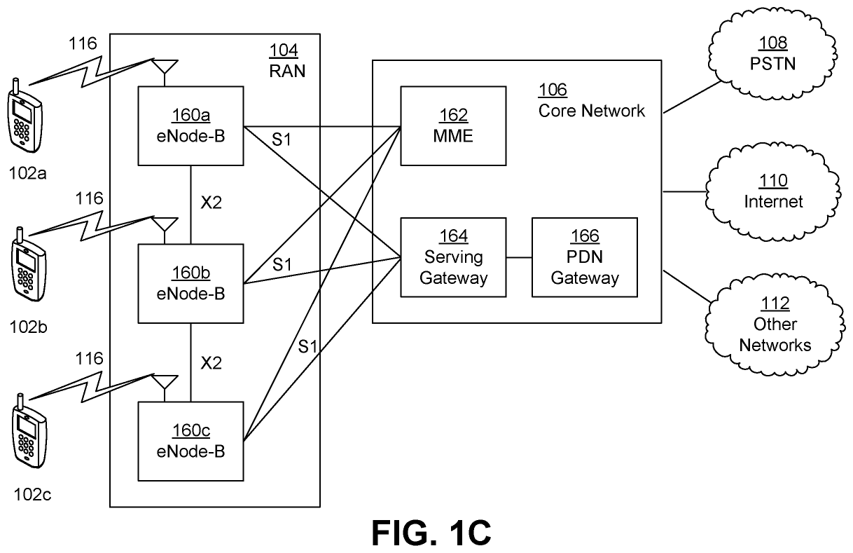

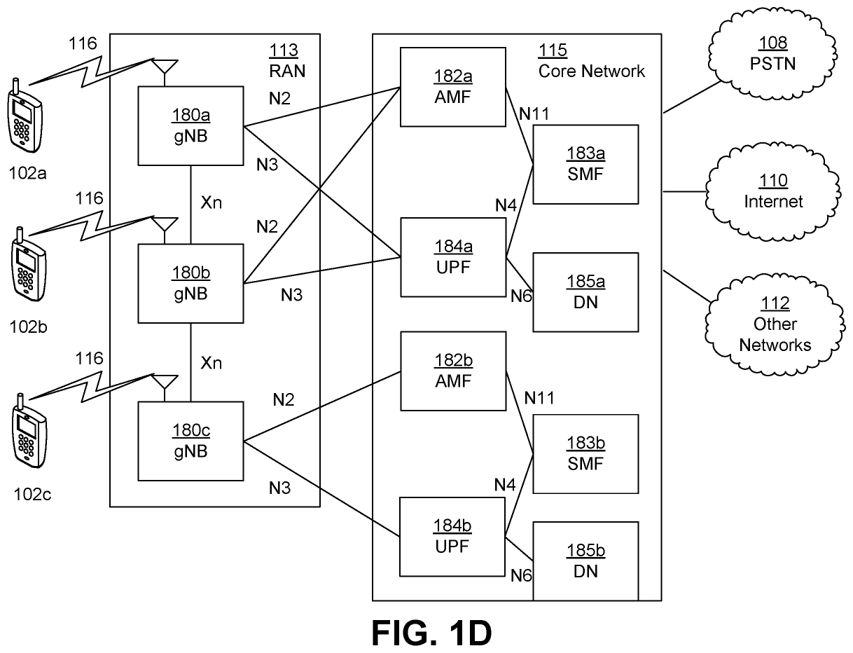

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for performing propagation delay compensation. For example, a Wireless Transmit/Receive Unit (WTRU) may be configured with the resources and signals to perform a Propagation Delay (PD) procedure, a Propagation Delay Information Exchange (PDIE), or a Propagation Delay Compensation (PDC).

The WTRU may receive configuration information. The configuration information may identify a reference signal (RS) pair for a path (e.g., a RS pair for each path of a number of path(s)). A path (e.g., each path of a number of path(s)) may be associated with at least one of: a bandwidth part (BWP), a carrier, a transmission/reception point (TRP), a cell, a beam, a TCI state, or a link type. RS pair(s) may be determined a function of QCL information, the TCI state, a transmission path, or a spatial relationship between RSs (e.g., two RSs).

The WTRU may determine that a trigger condition is satisfied for a path (e.g., of the number of path(s)). The trigger condition being satisfied may trigger the WTRU to perform a PDIE (e.g., or to determine the next behavior in a PDIE). In examples, the trigger condition (e.g., the trigger condition being satisfied for the path) may be associated with at least one of: a parameter of a path (e.g., of a number of path(s)) being changed, a PDC validity timer expiring, a PDC failure occurring, a measurement value, a random access (RA) procedure, a bandwidth part (BWP) or SCS change, a reception of a signal associated with a PDIE, a UL listen-before-talk (LBT) failure detection; beam switching; a beam failure detection; an UL transmission type or an UL transmission priority; a location and speed of the WTRU; cross-layer indication; a request from the WTRU; radio link failure (RLF); Hybrid Automatic Repeat Request (HARQ) ACK feedback; or a transmission of a RS.

The WTRU may receive a downlink (DL) RS for a path (e.g., for each path of a number of path(s)) and transmit a UL RS for a path (e.g., for each path of a number of path(s)). A DL RS and a UL RS (e.g., each DL RS and UL RS) may be associated with a RS pair for a path (e.g., a RS pair for each path of a number of path(s)). The WTRU may receive (e.g., from a gNB) a Rx-Tx time difference value for a path (e.g., for each path of a number of path(s)). The Rx-Tx time difference value may be associated with a Rx-Tx time different measurement report. The Rx-Tx time difference measurement report may include an index for a RS pair on which a time measurement is performed. In examples, the WTRU may perform measurements on a neighboring cell and measurement reporting associated with (e.g., as a function of) a Rx-Tx time difference value for a path (e.g., for each path of a number of path(s)).

The WTRU may determine a propagation delay (PD) for a path (e.g., of a number of path(s)). The PD may be determined based on at least: a timing of a received DL RS, a timing of a transmitted UL RS, and a received Rx-Tx time difference value. If the determined PD meets a threshold for the path (e.g., of a number of path(s)), the WTRU may apply a PDC to an UL transmission that uses the path (e.g., of a number of path(s)). The PDC may be based on the determined PD. In examples, the PDC applied to the UL transmission may be associated with a DRX cycle length or a DRX configuration. In examples, the determined PD may meet the threshold for the path if a PD value is above or below a threshold value. In examples, the PDC may include a first PDC value. The WTRU may determine the validity of the first PDC value based on if: a second PDC value is not received or calculated, the WTRU remains connected to the same TRP, or the WTRU remains within an area (e.g., the WTRU remains stationary or remains within a geo-fenced location).

The WTRU may be triggered to perform a PD procedure or PDIE or PDC as a function of at least one of: a measurement, a change in path, or receiving explicit indication. The WTRU may calculate a WTRU Rx-Tx time difference, receive a gNB Rx-Tx Time difference, and determine a PDC value. The WTRU may perform periodic PDC calculations. The WTRU may determine the validity of a PDC value based on whether a timer is active or expired. The WTRU may maintain multiple PDC values, where a PDC value may correspond to a set of paths. The WTRU may select a set of paths based on the PDC value associated with the set. The WTRU may maintain a PD procedure for a set of carriers (e.g., carriers for uplink (UL), DL or UL/DL). Examples of handling PD procedure when there is mobility are provided herein. Examples of determining PDC validity for DRX are provided herein. Examples for configurations of RS pairs are provided herein. Examples of measurement reports are provided herein. The measurement reports may include measurements and may (e.g., may also) include a set of RS indices. The RS indices may indicate (e.g., may each indicate) a RS associated to one or more measurements.

A WTRU may be configured with at least one of: a propagation delay mechanism, a measurement resource, a resource to receive gNB-based measurements, or triggers to perform PD information exchange and PDC. The WTRU may be triggered to perform a PD information exchange. The triggers to perform PD information exchange may include at least one of: reception of signaling from gNB, reception of RS, a change in measurement value by threshold amount, a RA procedure, a BWP/SCS change, a handover, a TCI state change, beam switching, beam failure detection, RLF, or UL LBT failure. The WTRU may begin or continue the PD information exchange. The PD information exchange may be composed of at least one of: a reception of DL RS, a reception of timing information, a determination of WTRU Rx-Tx time difference, a transmission of UL RS, or a reception of gNB Rx-Tx time difference. The WTRU may be triggered to determine a Propagation Delay Compensation (PDC). The WTRU may use PDC for an UL transmission. The triggers to perform PDC may include at least one of: being triggered to perform PD information exchange; a measurement value exceeding a threshold; a reception of an indication from a gNB; scheduling for UL transmission; an UL transmission type; a service type; a RS; PDC validity status; or a change in path type. The path type may be associated with at least one of: a carrier, a Transmission Reception Point (TRP), a beam, or a sidelink path.

A WTRU may be configured to transmit on one or more paths. A path may be associated with at least one of: a carrier, a TRP, a TCI state, a QCL index, a beam, a BWP or SCS. A WTRU may determine a set of paths for which to associate to a PDC value (e.g., a single PDC value). The WTRU may determine the set of paths as a function of at least one of: a carrier index, a TCI state, a QCL index, SCS, an indication from a gNB, or a measurement value (e.g., WTRU-based Rx-Tx time difference within a threshold value, gNB-based Rx-Tx time difference within a threshold value, PDC within a threshold value, etc.). The WTRU may indicate to the gNB the set(s) of paths that are associated with one or more PDCs. The WTRU may maintain the PDC value used for the set of paths as a function of: a maximum PDC value (e.g. the largest PDC value of one of the paths in the set of paths); a minimum PDC value (e.g. the smallest PDC value of one of the paths in the set of paths); or an average PDC value (e.g. the average PDC value obtained from some or all PDC values of the paths in the set of paths). The WTRU may maintain the PDC value used for the set of paths based on a master path on which PD information exchange occurs. The WTRU may select a path for a transmission based on a PDC value. The WTRU may apply the PDC to UL transmissions using one or more of the associated paths.

A WTRU may be configured with PD information exchange resources. The WTRU may determine a PDC value as an outcome of a PD information exchange procedure. The WTRU may start a timer when determining a PDC value. The WTRU may restart the timer based on at least one of: a new measurement being within threshold value of old measurement, reception of a new gNB-based Rx-Tx time difference with change from previous time difference less than threshold, or gNB feedback. The WTRU may be scheduled to transmit or determine to transmit on a configured resource. The WTRU may determine the PDC validity timer has expired. The WTRU may trigger a PD information exchange procedure. The WTRU may determine the PDC value. The WTRU may transmit in the UL using the PDC value.

Propagation delay may have a number of effects for Time-Sensitive Networks (TSN). In examples, in TSN, tight synchronicity accuracy levels may be required. The sources of error may include at least one of: Base Station (BS) timing (e.g., including Time Alignment Error), WTRU timing, DL propagation delay estimation, BS detecting error (e.g., SRS timing detection), TA indicating error and accuracy, or DL frame timing error, etc.

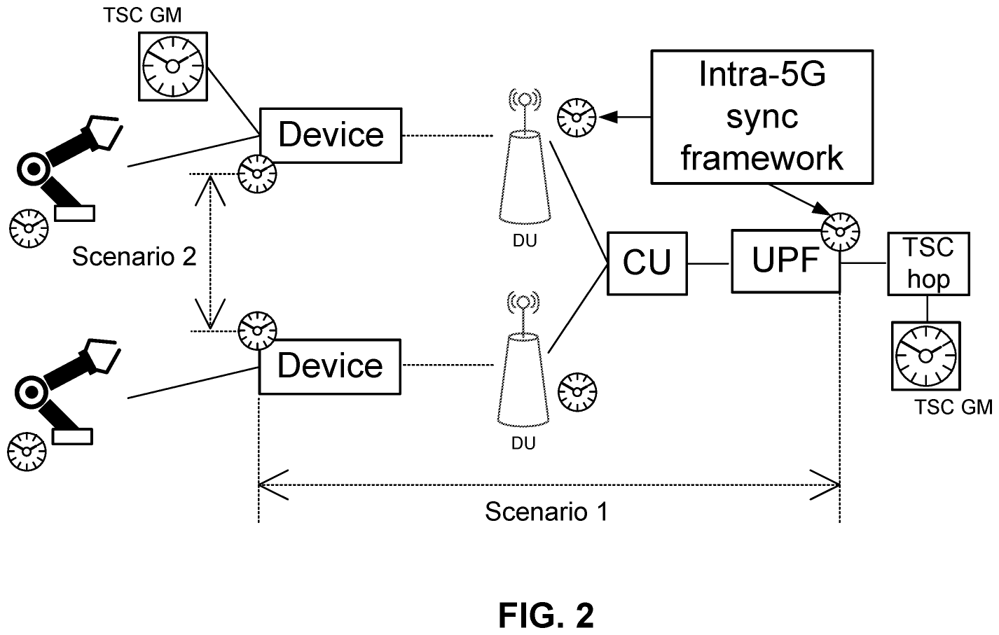

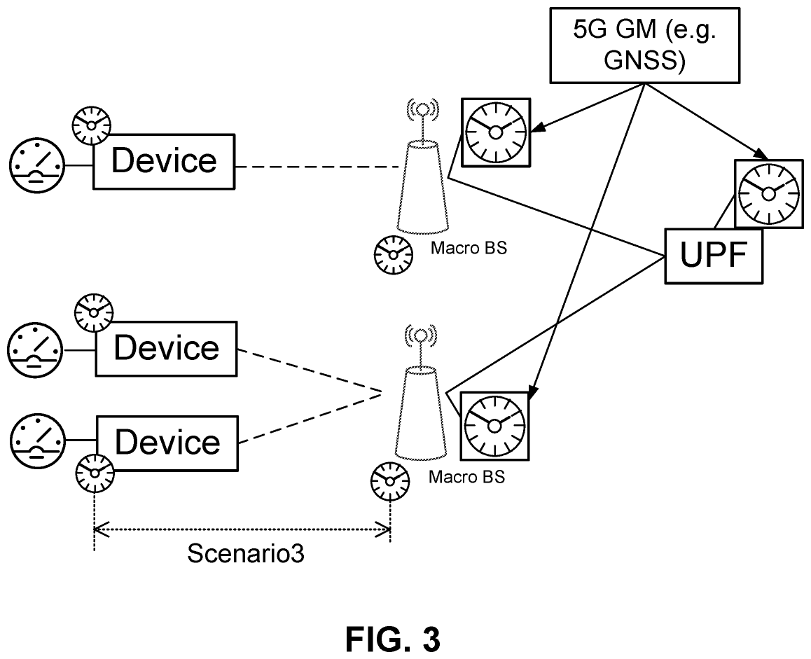

FIG. 2 shows an example of a control-to-control scenario. FIG. 3 shows an example of a smart-grid scenario. For the control-to-control scenario, a master clock may be found “behind” a source WTRU (e.g., in a device connected to the WTRU). The 5GS E2E budget may apply from the DS-TT (device-side TSN translator) timestamping entity at the source WTRU to the DS-TT timestamping entity at the target WTRU. The synchronization error may be doubled due to Uu interfaces (e.g., two Uu interfaces as shown in FIG. 2). For the smart-grid scenario, time synchronization may be required between PMUs (Phase Measurement Units), which may be very far apart. The 5GS E2E accuracy may be from the 5G GM to the DS-TT at a WTRU.

The TA may be enhanced (e.g., via enhanced TA granularity, via TA adjustment error, or via signaling separate from TA such that the TA procedure may not be affected). Synchronization may be addressed via RTT-based procedures (e.g., RAN managed Rx-Tx procedure). RTT-based procedures may apply the knowledge of a DL (or WTRU) Rx-Tx time difference and an UL (or gNB) Rx-Tx time difference. This may be achieved via measurements on RSs. The RSs may be wideband to enhance (e.g., ensure) precision.

Propagation delay compensation (PDC) may be used (e.g., if a propagation delay is known). PDC compensation may be performed at the WTRU side. The WTRU side compensation PDC may be TA-based or include RTT-based procedures. For RTT-based procedures, a WTRU may measure the WTRU Rx-Tx time difference and may receive the gNB Rx-Tx time difference from the gNB. The WTRU may calculate the propagation delay and may compensate the received reference timing. Pre-compensation PDC may be performed at the gNB side. gNB side pre-compensation PDC may include RTT-based procedures. For RTT-based procedures, the WTRU may measure the WTRU Rx-Tx time difference and may report it to the gNB. The gNB may measure the gNB Rx-Tx time difference and may pre-compensate the reference timing information before transmitting to the WTRU.

Examples of signaling and transmitting signals and measurements to determine propagation delay of one or more links (e.g., where multiple links are assumed in a multi-hop scenario or in a control-to-control scenario) are provided herein. Examples of enhancing (e.g., ensuring) time sensitive communication operating with the required reliability and latency despite the need for PDC are provided herein. Examples of enhancing (e.g., ensuring) PDC is maintained with the required accuracy are provided herein. Examples of signaling and determining PD and PDC for cases where there are multiple carriers, DRX, and mobility are provided herein. Examples of configurations of WTRU-based PRC are provided herein.

For a PD information exchange procedure, the propagation delay of a path may be determined by a WTRU or gNB by means of a propagation delay information exchange (PDIE). The PDIE may be used by the WTRU to determine an appropriate propagation delay compensation (PDC) value for an UL transmission. The PDC may be WTRU-based or gNB-based (e.g., pre-compensation at the gNB). The PDC may enable transmission alignment(s) along one or more paths or hops. In examples, the PDC may enable timing alignment(s) for a transmission from a first WTRU to a first gNB and from a second gNB to a second WTRU (e.g., where the first and second gNB may be the same). The PDC may enable clock alignment at node(s) (e.g., at all nodes). In examples, a first WTRU may be associated to a clock timing. The PDC may ensure that a clock timing at a gNB or a second WTRU is aligned with the clock at the first WTRU.

The PDC may be centralized and performed at a node. The node performing the PDC may receive measurements from other nodes (e.g., a Rx-Tx time difference at all nodes in the path (e.g., transmission path)). The PDC may be distributed. For path(s) or hop(s) (e.g., each path or hop in a multi-hop transmission), one node may perform PDC. For hop(s) (e.g., for each hop), there may be a node that may receive required measurements from other nodes (e.g., all other nodes) in the hop(s).

The PDIE may include one or more of: a transmission of a RS by the WTRU; a reception of a RS by the WTRU; a transmission or reception of a WTRU Rx-Tx time difference by the WTRU; or a reception of a gNB Rx-Tx time difference by the WTRU. The PDIE may be performed between a WTRU and the gNB or between two WTRUs (e.g., on the sidelink). For the case of WTRU-to-WTRU propagation delay calculation, a first WTRU may be considered the one calculating and implementing the PDC and a second WTRU may be considered as the one reporting measurements to the first WTRU to enable PDC calculation.

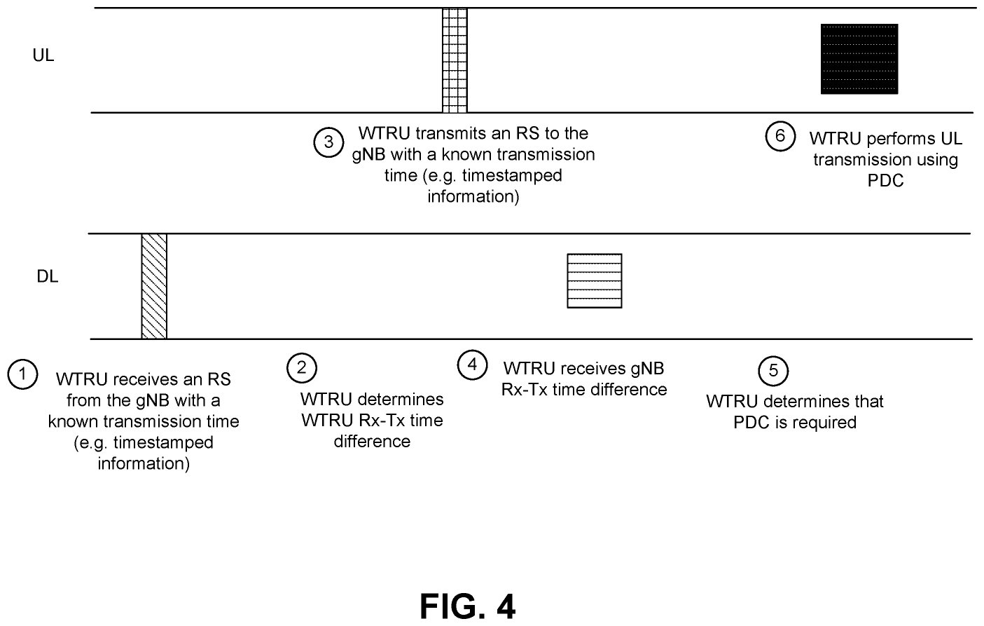

FIG. 4 shows an example of a PDIE procedure to enable a WTRU-based PDC. In the PDIE procedure, a WTRU may receive a signal (e.g., a RS) on which the WTRU may perform a measurement. The signal (e.g., RS) may have a known transmission time (e.g., the time at which the transmitting node transmitted the signal). The transmission time may be obtained via a timestamp from the signal itself or from another signal/transmission. In the PDIE procedure, the WTRU may determine the WTRU Rx-Tx time difference as a function of the transmission time and the time the WTRU received the signal. The WTRU may transmit an UL signal in the PDIE procedure. The UL signal may (e.g., may also) be time stamped to indicate the transmission time. The UL timestamp may be encoded into the UL signal transmission. In examples, the WTRU may select a parameter of the UL signal as a function of the transmission time. In examples, the WTRU may indicate (e.g., may explicitly indicate) the transmission time. In the PDIE procedure, the WTRU may receive the gNB Rx-Tx time difference. Using the WTRU Rx-Tx time difference and the gNB Rx-Tx time difference, a WTRU may determine the propagation delay. In the PDIE procedure, the WTRU may determine the PDC to be used to enhance (e.g., ensure) accurate timing of a transmission (e.g., subsequent transmission) in PDIE procedure. The PDIE procedure may be used for sidelink propagation delay information exchange by replacing the WTRU with a first WTRU and the gNB with a second WTRU.

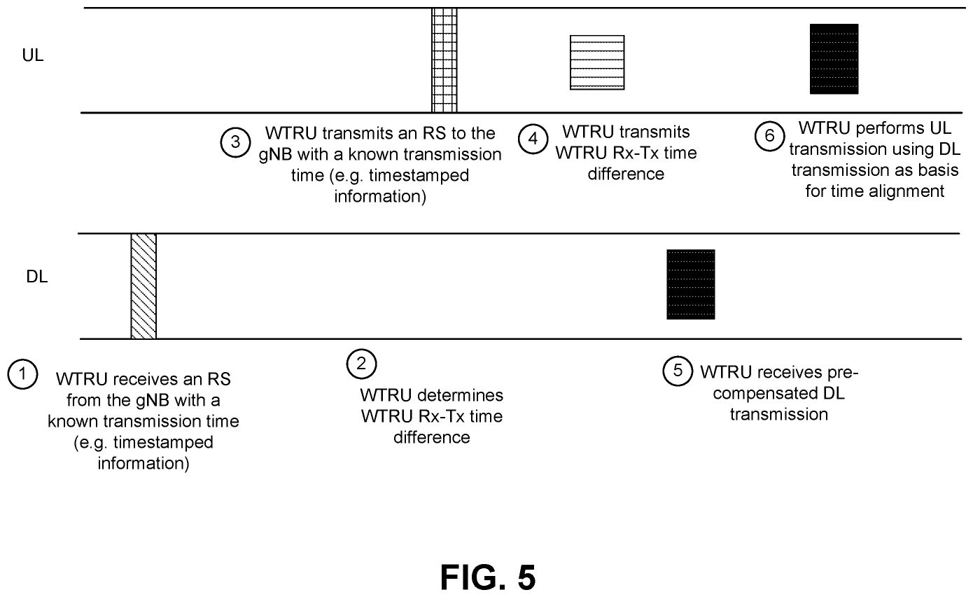

FIG. 5 shows an example of a PDIE procedure to enable gNB-based pre-compensation. The procedure described in FIG. 5 may (e.g., may also) be used to enable a second WTRU to perform pre-compensation for a transmission to a first WTRU on the sidelink. In the PDIE procedure, a WTRU may receive a signal (e.g., an RS) on which the WTRU may perform a measurement. The signal (e.g., RS) may have a known transmission time (e.g., the time at which the transmitting node transmitted the signal). The transmission time may be obtained via a timestamp from the signal itself or from another signal/transmission. In the PDIE procedure, the WTRU may determine the WTRU Rx-Tx time difference as a function of the transmission time and the time the WTRU received the signal. The WTRU may transmit an UL signal in the PDIE procedure. The UL signal may (e.g., may also) be time stamped to indicate the transmission time. The UL timestamp may be encoded into the UL signal transmission. In examples, the WTRU may select a parameter of the UL signal as a function of the transmission time. In examples, the WTRU may indicate (e.g., explicitly indicate) the transmission time. In the PDIE procedure, a WTRU may transmit the WTRU Rx-Tx time difference to the gNB (or to another WTRU). The WTRU may be indicated if pre-compensation is applied at the gNB (or the other WTRU) on a received transmission. The WTRU may align its transmission based on the timing of the received transmission.

Examples of configuration elements are provided herein. A WTRU may be configured with a propagation delay (PD) procedure. Such a PD procedure may enable a PD determination, PDIE, and/or PDC. The WTRU may receive the configuration information via higher layer signaling (e.g., Radio Resource Control (RRC)) or Physical Layer (PHY) layer signaling. The configuration information may identify a RS or RS pair for a path (e.g., a RS pair for each path of a number of path(s)). The PD procedure configuration information may indicate at least one of: a PDC type; a PDIE procedure; a RS configuration; a transmission time stamp indication resource; a measurement reporting resource; triggers; a path on which to perform the PD procedure; a number of total hops in the path; or an offset value. In examples, the PDC type indication may indicate whether the PDC type is WTRU-based, gNB-based, or pre-compensated at another node. In examples, the PDC type indication may indicate whether the PDC type is TA-based or RTT-based. As described herein, a path (e.g., each path of a number of transmission path(s)) may be or may be associated with at least one of: a bandwidth part (BWP), a carrier, a TRP, a cell, a beam, a TCI state, or a link type. RS pair(s) may be determined by configuration or as a function of QCL information, the TCI state, the path, or a spatial relationship between RSs (e.g., two RSs).

For the PDIE procedure, the PDIE procedure may indicate the PDIE procedure type (e.g., WTRU-based or gNB-based) to the WTRU and/or an order of performance for features of the procedure, such as those shown in the figures herein.

For the RS configuration (e.g., for a received RS configuration), a WTRU may be configured with (e.g., may receive) a DL RS on which it may perform measurements and an UL RS to transmit to the gNB (or other WTRU), for example the pair may be for a path (e.g., where respective RS pairs may be for respective paths of a number of paths). The two RSs may be associated (e.g., the DL RS and the UL RS) with a respective RS pair for path(s) (e.g., for each transmission path of a number of paths). The RS configuration information may include a set of parameters that may be determined as a function of the transmission timing of the RS. In examples, a WTRU may determine the transmission timing of a DL RS based on one or more parameters of the RS. This may enable the WTRU to determine a WTRU Rx-Tx time difference. In examples, a WTRU may select a parameter of an UL RS as a function of the transmission time of the RS. A RS used for PD may span one or more BWPs or carriers. In examples, a RS configuration may be associated with a part of a RA procedure (e.g., may be a function of part of a RA procedure). The RS configuration may be periodic, semi-persistent (e.g., via an activation trigger and/or a deactivation trigger), or aperiodic. A RS configuration may include (e.g., may be composed of) RS pair(s). A RS pair may include an UL RS and an associated DL RS. A RS pair occasion may include (e.g., may be composed of) an occasion of a DL RS and an occasion of an associated UL RS.

For the transmission time stamp indication resource, a WTRU may be configured with resources on which to receive the DL RS transmission time stamp. In examples, a WTRU may receive the DL RS transmission time stamp in a Downlink Control Information (DCI) or a DL MAC CE (e.g., possibly of a transmission associated with the DL RS). A WTRU may be configured with resources on which to transmit the UL RS transmission time stamp. In examples, the WTRU may transmit the UL RS transmission time stamp in a PUSCH, a PUCCH, or an UL MAC CE (e.g., possibly of a transmission associated with the UL RS).

For the measurement reporting resource, a WTRU may be configured with resources on which to report measurements performed on the DL RS and possibly using the DL RS time stamp. Such resources may be in a PUSCH, a PUCCH, or a MAC CE. In examples, a WTRU may request resources to transmit measurement reports for PD measurements. In examples, a WTRU may be configured with resources on which to receive a gNB measurement (e.g., gNB Rx-Tx time difference). Such a resource may include a DCI or a DL MAC CE. The DCI may be a scheduling DCI or a non-scheduling DCI, possibly dedicated to the indication of the gNB measurement.

For the triggers, a WTRU may be configured with one or more triggers. The triggers may be for PDIE or PDC.

For the path on which to perform the PD procedure, one or more of the following may apply. A WTRU may be configured with one or more paths on which to perform the PD procedure. The paths may be associated with (e.g., may be defined by) at least one of: a Bandwidth Part (BWP); a carrier; a TRP; a cell (e.g., PCell, SCell); a beam, a TCI state, a QCL index link type (e.g., sidelink or UL/DL); or a source or destination node type or index.

For the number of total hops in the path, one or more of the following may apply. The number of total hops in the path indicated in the configuration information may indicate to the number of wireless links in a path from source to destination node. The number of total hops in the path indicated in the configuration information may indicate to the WTRU the number of paths on which PDC may be required or performed.

For the offset value in the configuration information, one or more of the following may apply. The offset value in the configuration information may indicate to the WTRU an offset value that may be used to determine one or more PD values. The offset value may represent a delay in the network that is not measurable via the PDIE procedure.

Examples of measurements and measurement reports are provided herein. A WTRU may perform and report measurements supporting PDIE. The reported measurement may be obtained from one or more of a measurement on a DL RS, or a time stamp of the DL RS, where the time stamp of the DL RS may be received in an associated transmission. A WTRU may (e.g., may also) receive measurements from another node (e.g., gNB or WTRU). The measurements transmitted and received by the WTRU may be used to determine the PD of a path or link. The measurements transmitted or received may include at least one of: a Rx-Tx time difference (e.g., Rx-Tx time difference(s) associated with RS pair(s) as disclosed herein); a RS index; a RS occasion; a propagation delay; a WTRU speed/position; AoA/AoD; a timing error; a network processing or routing delay; a request for measurement report; a PDC value used in one or more links of a path; or a timing difference between when a transmission is expected to be received and when it was actually received.

For the Rx-Tx time difference, the WTRU may measure and report a WTRU Rx-Tx time difference. In examples, a WTRU may receive a gNB Rx-Tx time difference or a WTRU Rx-Tx time difference from a second WTRU. In examples, a WTRU may receive a Rx-Tx time difference value for a path (e.g., for each path of the number of path(s)). The Rx-Tx time difference value may be associated with a Rx-Tx time difference measurement report. In examples, a WTRU may transmit over hops (e.g., two hops) using a simple repeater. The WTRU may receive two repeater Rx-Tx time difference values (e.g., one for each hop) and a WTRU Rx-Tx time difference (e.g., for the link between the second WTRU and the repeater). This may enable a first WTRU to perform PDC for the multiple hops.

For the RS index, a report (e.g., either received by the WTRU or transmitted by the WTRU) may include the RS index on which at least one measurement is made. In examples, the report may include the RS index on which a Tx timing measurement is made and a RS index (e.g., another RS index) on which a Rx timing measurement is made. In examples, the report may include the RS pair index. The RS pair index may indicate a pair of RSs on which Rx and Tx timing measurements may be made.

For the RS occasion, a report may include the occasion (e.g., timing or resource or instance) of a RS on which a measurement is performed.

For the propagation delay, the WTRU may receive one or more values of propagation delays for one or more paths or one or more hops in a path.

For the WTRU speed/position, the WTRU may report its speed and/or position within a cell. The speed may be determined as a change in position over a fixed amount of time, or since a last report. For the AoA/AoD, a WTRU may report an AoA or an AoD to another node (e.g., a gNB or a WTRU). A WTRU may receive a report of an AoA or an AoD from another node (e.g., a gNB or a WTRU).

For the timing error, the timing error may be determined based on a time-stamped value of an associated transmission. For the network processing or routing delay, the WTRU may receive a value that may be used to determine the network processing or routing delay. In examples, a WTRU may receive a value representing a processing or routing delay for one or more nodes in a multi-hop path or link.

For the request for measurement report, a WTRU may transmit or receive a request for a measurement report. The WTRU may transmit the request to trigger PDIE at another node. The WTRU may receive the request to trigger the PDIE at the WTRU. For the PDC value used in one or more links of a path, a first WTRU may transmit to a second WTRU via a gNB. Each WTRU to gNB link may be associated with a PDC. A first WTRU may receive a PDC value used for the gNB to a second WTRU link. This may also be applicable to different links in a multi-hop scenario. The WTRU may transmit a PDC value used for its link to the first receiver (e.g., gNB). For the timing difference between when a transmission is expected to be received and when it was actually received, this may be considered a PDC error report.

Examples of reporting resources are provided herein. A WTRU may transmit or receive a measurement or report or indication to support a PD procedure. The WTRU may be configured with resources on which to transmit or resources on which to receive transmissions (e.g., different transmissions) associated to a PDIE. The resources on which the WTRU may transmit or receive a measurement, a report, or an indication possibly associated to a PDIE may include at least one of: a PUCCH; a PUSCH; a MAC CE; a PDCCH; a sidelink resource; a cross-carrier resource; a part of a Random Access (RA) procedure; or RRC signaling.

For the PUCCH, a WTRU may transmit a measurement report in a CSI feedback report. For the MAC CE, a WTRU may provide a measurement report or indication in an UL MAC CE. For the MAC CE, a WTRU may receive a measurement report or indication in a DL MAC CE. In examples, such MAC CEs may (e.g., may only) be transmitted with data. In examples, such MAC CEs may be transmitted without any data. For the PDCCH, a WTRU may receive a measurement or indication in a DCI. The DCI may indicate the path or transmission to which a PD measurement is applicable. The DCI may be a scheduling DCI or a non-scheduling DCI. A scheduling DCI that includes a PD procedure measurement, report, or indication may be used to schedule a RS to be used in a PDIE. In examples, an example PDCCH transmission may be reserved for the WTRU reception of a measurement, report, or indication from a gNB or another WTRU. For the cross-carrier resource, a WTRU may be configured with a resource on one or more carriers (e.g., a resource spanning multiple carriers) or one or more BWPs (e.g., a resource spanning multiple BWPs) on which the WTRU may transmit or receive a measurement, report, or indication to support PD procedure. For the part of a RA procedure, a measurement, report, or indication may be included in at least one of: a PRACH preamble or msg1; a MsgA preamble or PUSCH; a msg2 or RAR; a MsgB; a msg3; or a msg4.

A reporting resource may be determined as a function of the RS used for Rx timing measurements, the RS used for Tx timing measurement, or the RS pair. The timing of a reporting resource may be associated with (e.g., may be determined as a function of) the timing of a RS or RS pair. The RS index may not (e.g., may not need to) be indicated (e.g., explicitly indicated) in a measurement report if the timing of a reporting resource is be determined as a function of the timing of an RS or RS pair.

A measurement report or indication supporting PD procedures (e.g., as part of PDIE) may be assigned a priority. In examples, such a measurement report or indication may have highest priority and may pre-empt other transmissions on the resources. In examples, such a measurement report or indication may have highest priority and may receive guaranteed resources if multiplexed with other transmissions.

Examples of trigger(s) (e.g., trigger condition(s)) to begin PD information exchange or PDC are provided herein. Examples of event based trigger(s) (e.g., trigger condition(s)) are provided herein. A WTRU may be triggered to perform a PD procedure, a PDIE, a part of a PDIE, or apply a PDC. The trigger(s) (e.g., trigger condition(s)) may themselves be a part of a PD procedure or a part of a PDIE. In examples, any part of a PDIE as described herein may be used to trigger another part of the PDIE. In examples, the value of a measurement obtained in a part of the PDIE may be used to determine whether to trigger another part of the PDIE.

Trigger(s) (e.g., trigger condition(s)) may be used by a WTRU to determine a behavior (e.g., the next behavior) in a PD procedure or PDIE. Trigger(s) (e.g., trigger condition(s)) may be evaluated at a WTRU where a master clock may be located or at another WTRU or gNB. The trigger(s) (e.g., trigger condition(s)) may include at least one of: a parameter of a path (e.g., of a number of path(s)) being changed, a PDC validity timer expiring, a PDC failure occurring, a measurement value, a RA procedure, a BWP or SCS change, a reception of a signal associated with a PDIE, an UL LBT failure detection; beam switching; beam failure detection; a service type, an UL transmission type or UL transmission priority; location and speed of a WTRU; a timing error; a cross-layer indication; a WTRU request; RLF; expiration of a timer; Hybrid Automatic Repeat Request (HARQ) ACK feedback; a transmission of a RS, PDC validity, or a change of path or path type.

For a measurement value, a WTRU may obtain a measurement for a PD procedure. If the measurement is above or below a value, the WTRU may be triggered to perform a PD procedure, perform a PDIE, or apply PDC. In examples, a WTRU may receive an RS (e.g., possibly with a transmission time stamp) in the PDIE procedure. The WTRU may obtain a WTRU Rx-Tx time difference value for a path (e.g., for each path of a number of path(s)). The WTRU Rx-Tx time difference value may be associated with a Rx-Tx time difference measurement report. If the value is above or below a threshold, the WTRU may be triggered to proceed with the PDIE procedure. In examples, a WTRU may perform a PDIE and determine a PD value. If the PD meets a threshold (e.g., if the PD value is above or below a threshold value), the WTRU may perform PDC (e.g., may apply a PDC to an UL transmission using a path based on the determined PD). The threshold value may be dependent on a specific transmission (e.g., or transmission type) for which the PDC may be applied. In examples, the WTRU may receive a measurement report from another node (e.g., a gNB or a WTRU) and may compare a measurement value associated with measurement report to a threshold value. Depending on if the measurement value is above or below the threshold value, the WTRU may continue with PDIE or apply PDC.

For the RA procedure, a WTRU may be triggered to perform a PD procedure, begin a PDIE, continue a PDIE, or apply PDC if triggered to perform a RA. In examples, a WTRU may be triggered to begin a PDIE, continue a PDIE, or apply PDC based on the reception of a transmission as part of a RA procedure. For the BWP or SCS change, a WTRU may be triggered to perform a PD procedure, a PDIE, or apply PDC when changing the BWP or SCS. For the UL LBT failure detection, a WTRU may be triggered to perform a PD procedure, a PDIE, or apply PDC when UL LBT failure is being detected. For beam switching, WTRU may be triggered to perform a PD procedure, a PDIE, or apply PDC if a TCI state is changed or an associated QCL index is changed from a previous transmission.

For the service type, the WTRU may determine whether to trigger a PD procedure, a PDIE, or apply PDC based on the service type (e.g., URLLC, eMBB, mMTC, Time Sensitive Communication) or QoS requirements of a transmission (e.g., subsequent transmission). For the UL transmission type or UL transmission priority, a WTRU may determine to trigger a PD procedure, a PDIE, or apply PDC based on the UL transmission priority of an associated or upcoming UL transmission. For the location and speed of a WTRU, a WTRU may determine whether to trigger a PD procedure, a PDIE, or apply PDC based on the location or change in location since a previous transmission or speed of the WTRU.

For the timing error, the WTRU may determine a timing error between an expected reception of a transmission and the actual reception timing of the transmission. Based on the timing error and possibly compared to a threshold, the WTRU may trigger a PD procedure, a PDIE, or apply PDC. For cross-layer indication, a WTRU may receive an indication from an application layer to trigger a PD procedure, a PDIE, or apply PDC. For a WTRU request, a WTRU may request another node (e.g., gNB or other WTRU) to begin a PD procedure, a PDIE, or apply PDC.

For HARQ ACK feedback, a WTRU may determine whether to trigger a PD procedure, a PDIE, or apply PDC based on the reception of HARQ ACK feedback or based on the contents of a DL or UL HARQ ACK feedback. In examples, a WTRU may determine that more than n HARQ processes have been NACKed and based on this, the WTRU may trigger a PD procedure, a PDIE, or apply PDC.

Examples of explicit signaling are provided herein. A WTRU may receive or transmit signaling to begin, stop, activate, or deactivate a PD procedure, a PDIE, or apply or stop applying PDC. The signaling may be tied to a UL transmission (e.g., subsequent UL transmission). The explicit signaling triggering or activating or deactivating a PD procedure, a PDIE, or application of PDC may include at least one of: higher layer signaling; PHY laying signaling; reception or transmission of a signal; reception or transmission of a request to activate or deactivate a PD procedure, a PDIE, or application of PDC; reception or transmission of a request via sidelink; assistance information to or from another WTRU; an indication that PDC is applied or is no longer applied; an aperiodic RS or measurement report trigger; or reception or transmission of a part of the PDIE procedure.

For higher layer signaling, a signal (e.g., RRC) may activate or deactivate a PD procedure, a PDIE, or application of a PDC. For PHY layer signaling, the PHY layer signaling may include a DCI or a MAC CE. A WTRU may receive a DCI or a MAC CE activating or deactivating a PD procedure, a PDIE, or application of a PDC. For the reception or transmission of a signal, reception or transmission of a RS may activate a PD procedure, a PDIE, or application of a PDC.

For the reception or transmission of a request via sidelink, a WTRU may receive or transmit a request via a sidelink from or to a second WTRU to activate or deactivate a PD procedure, a PDIE, or application of a PDC. For assistance information to or from another WTRU, a first WTRU may receive assistance information from a second WTRU indicating the activation or deactivation (e.g., the need to activate or deactivate) a PD procedure, a PDIE, or application of a PDC. For an indication that a PDC is applied or is no longer applied, a WTRU may receive or transmit an indication that a PDC is newly applied or no longer applied. Such an indication may be used by a WTRU (e.g., another WTRU) to activate or deactivate a PD procedure, a PDIE, or application of a PDC. In examples, a WTRU may receive an indication that PDC pre-compensation is applied at another node and the WTRU may deactivate its own PDC. For an aperiodic RS or measurement report trigger, a WTRU may activate or deactivate a PD procedure, a PDIE, or application of a PDC based on the reception and contents of an aperiodic RS or measurement report trigger. For reception or transmission of a part of the PDIE procedure, the WTRU receiving a transmission of a part of the PDIE (e.g., as described herein) may be triggered to continue with another part of the PDIE procedure.

Examples of a periodic PDC are provided herein. A WTRU may be configured with periodic resources on which to perform PD procedures or a PDIE. The WTRU may be configured with at least periodic DL and UL resources or periodic measurement reporting transmission or reception resources. In examples, a WTRU may expect a periodic measurement report from another node. If the WTRU does not receive an expected measurement report from another node (e.g., in a periodic reporting resource), the WTRU may perform at least one of: monitor a fallback resource on which the WTRU receives a measurement report; apply or reuse a value obtained from a previous measurement report associated with the PD procedure of that path; transmit a request for a retransmission of the measurement report; use a default value in place of the missing measurement; apply maximum or minimum PDC; deactivate either a PD procedure, a PDIE, or a PDC application; or trigger a PD procedure or a PDIE.

A WTRU may obtain a measurement or measurement report from which it may determine a PD. The WTRU may update a PDC if the measurements indicate that it has changed by an amount greater than a threshold (e.g., threshold value). If updating PDC, a WTRU may indicate to other nodes (e.g., gNB or another WTRU) that the WTRU has updated the PDC used for a transmission.

A WTRU may monitor the validity of a PDC value (e.g., a first PDC value), wherein a PDC value (e.g., the first PDC value) may be defined as valid subject to one or a combination of the following: a requirement, threshold, value range, or criteria is satisfied; an event-based trigger causes the WTRU to declare the PDC value invalid; a time duration; a PDC value (e.g., a second PDC value) is not received or calculated; the WTRU remains connected to the same TRP; the WTRU remains stationary, or the WTRU remains within a geo-fenced location.

Regarding the requirement, threshold, value range, or criteria being satisfied, a PDC may be declared as valid if the total path delay, or a subsection of path delay (e.g., NR Uu interface) is less than an absolute value. Regarding an event-based trigger that may cause the WTRU to declare the PDC value invalid, a WTRU may declare a PDC value as invalid if one or more of the previously defined event-based trigger(s) occurs.

Regarding a time duration, the WTRU may monitor the duration of a PDC value by tracking a time (e.g. via a PDC validity timer). The time may be started when receiving or calculating a PDC value. While the time is running, the WTRU may declare the PDC value as valid. If the time expires, the WTRU may declare the PDC value as invalid. The time may be stopped if receiving a RRC message such as a RRC release, a RRC release with suspend, RRC reject. The time may be stopped if a conditional handover is executed, a handover command is received, or if other WTRU mobility functions are performed. The time may be restarted if one or more of the following occurs: the WTRU receives a PDC value (e.g., a new PDC value); transmission or reception of a measurement report; a periodic time-stamp of transmission; certain DRX parameter conditions occur (e.g., at next ONduration a PDC is no longer valid).

Regarding a PDC value (e.g., a new PDC value) not being received or calculated, if receiving or calculating an updated PDC value, the WTRU may declare the previous value as invalid. Regarding the WTRU remaining connected to the same TRP, if the WTRU performs mobility to a cell (e.g., a new cell), IAB node, or TRP, the WTRU may declare the PDC value as invalid.

Regarding the WTRU remaining stationary or remaining within a geo-fenced location, the WTRU may declare itself as stationary subject to RSRP/RSRQ measurement thresholds or based on device type. The WTRU may receive information regarding a geo-fenced area where the PDC may remain valid, such as a radius and origin point, or a latitude/longitude range. The WTRU may evaluate that the WTRU within (e.g., is still within) the geo-fenced area, possibly periodically, using network positioning methods, GNSS, GPS, or other positioning techniques. If the WTRU detects that it is no longer within the geo-fenced area, it may declare the PDC value as invalid.

The WTRU may monitor the PDC validity of the packet periodically or may evaluate the validity subject to a triggering event (e.g., such as those defined previously). The WTRU may select a procedure to evaluate PDC validity periodicity or a set of parameters/values within an evaluation procedure, apply a different evaluation method, use a combination of procedures, or change combinations of procedures based on one or more of the following: a network configuration or explicit indication (e.g., for example, via RRC configuration signaling, indication in SIB, MAC CE, or DCI); WTRU characteristics or WTRU state (e.g., for example, WTRU speed (e.g., via mobility state estimation), WTRU device type, level of measurement relaxation, whether the WTRU is defined as stationary, location of the WTRU within the cell (e.g., whether the WTRU is located at the cell edge)); network deployment scenario (e.g., for example, whether the WTRU is within a smart grid, a reference clock is located or maintained within the network (e.g., total path delay includes one NR-Uu interface), or reference clock is located or maintained by another WTRU (e.g., total path delay includes two NR-Uu interfaces)); packet or transmission characteristics (e.g., for example, based on the remaining survival time, or QoS/5QI requirements); or mobility to a cell (e.g., new cell) or connection to a TRP (e.g., a new TRP).

Examples of PDC failure detection and recovery are provided herein. The WTRU may determine that the PDC value is no longer applicable and declare PDC failure. The WTRU may declare PDC failure if one or more of the following occur: the WTRU declares that a PDC value is invalid; a PDC value or update to a previous PDC value has been unsuccessfully received or calculated (e.g., the WTRU may determine that the WTRU failed to receive or calculate a PDC value, for example, if it has not received an updated value after a time offset T from the transmission of a PDC update request, the transmission was unable to be successfully decoded, or the WTRU has performed mobility prior to reception of the PDC value update); an indication from the network is received; the survival time expires or there is an unsuccessful transmission/reception of a packet within packet delay budget; or the WTRU enters an on-duration in a DRX cycle.

In the event of a PDC failure, the WTRU may perform one or more of the following actions: report a PDC failure to the network; a RA; a BWP switch; a timing advance request; a PD information exchange request; transmission of a PD RS; or transmission of a Rx-Tx time difference as determined by the WTRU.

Examples of PD, PDC, and PDIE procedures are provided herein. Examples of maintenance of multiple PD procedures are provided herein. A WTRU may maintain multiple PD procedures (e.g., possibly simultaneously). The WTRU may calculate and maintain multiple PDC values (e.g., one per PD procedure). A PD procedure or a PDC value may be associated with at least one of: a path; a carrier; a beam, a TCI state, a QCL index; a cell; a TRP; a link type (e.g., sidelink); a link (e.g., for a multi-hop path with multiple links); or a RS index (e.g., the RS index may indicate one of a DL RS, an UL RS, a SL RS, or a RS pair).

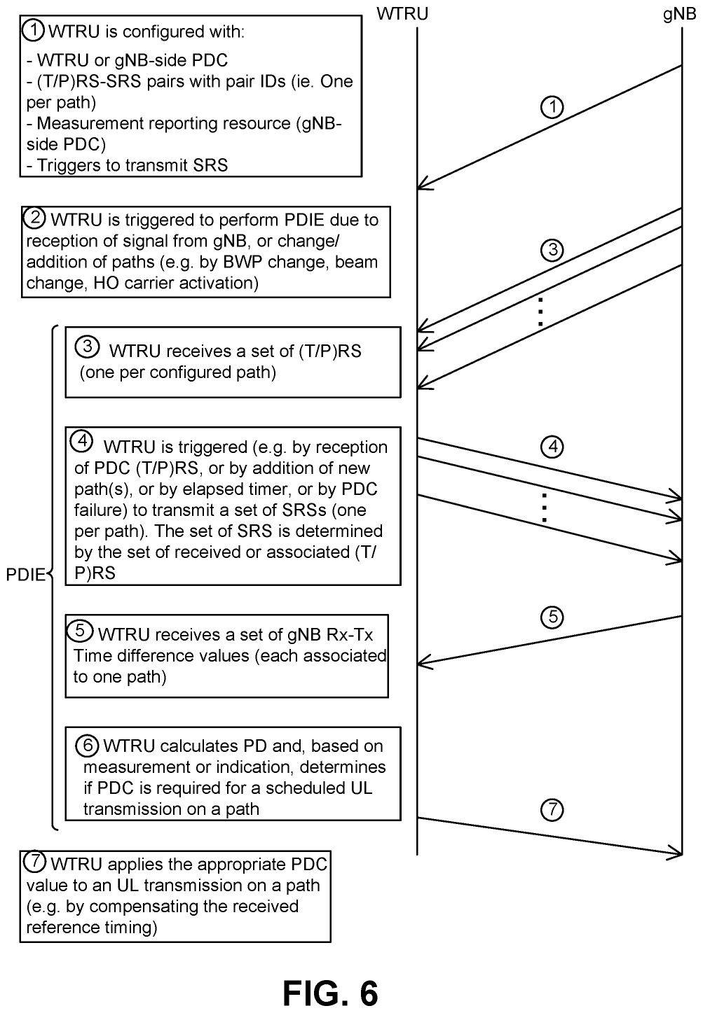

FIG. 6 illustrates an example of a WTRU performing a PD procedure. As described herein, the WTRU may receive configuration information. The configuration information may identify a set of RSs or RS pair(s). A RS pair (e.g., each RS pair) may be associated with a path (e.g., of a number of paths). The RS pairs may be determined as a function of QCL information, a TCI state, a path, or a spatial relationship between RSs (e.g., two RSs). The WTRU may determine the set of RSs (e.g., two RSs) that include (e.g., compose) a RS pair. The WTRU may be configured with one or more RS pairs and may assume that RSs within a RS pair are QCL, share a TCI state, or share a path.

As described herein, the WTRU may determine that a trigger condition is satisfied for a path (e.g., of a number of path(s)). The trigger condition being satisfied may trigger the WTRU to perform a PDIE (e.g., or to determine the next behavior in a PDIE). In examples, trigger condition may be satisfied for the path if a parameter of a path (e.g., of a number of path(s)) is changed, a PDC validity timer has expired, or a PDC failure occurs. In examples, the trigger condition (e.g., the trigger condition being satisfied for the path) may be associated with at least one of: a parameter of a path (e.g., of a number of path(s)) being changed, a PDC validity timer expiring, a PDC failure occurring, a measurement value, a RA procedure, a BWP or SCS change, a reception of a signal associated with a PDIE, a UL LBT failure detection; beam switching; beam failure detection; a UL transmission type or UL transmission priority; a location and speed of the WTRU; a cross-layer indication; a request from the WTRU; RLF; Hybrid Automatic Repeat Request (HARQ) ACK feedback; or a transmission of a RS.

As described herein, the WTRU may receive a DL RS for a path (e.g., for each path of the number of path(s)) and transmit a UL RS for a path (e.g., for each path of a number of path(s)). A DL RS and a UL RS (e.g., each DL RS and UL RS) may be associated with a RS pair for a path (e.g., a RS pair for each path of a number of path(s)). The WTRU may receive (e.g., from a gNB) a Rx-Tx time difference value for a path (e.g., for each path of a number of path(s)). The Rx-Tx time difference value may be associated with a Rx-Tx time different measurement report. The Rx-Tx time difference measurement report may include an index for a RS pair on which a time measurement is performed. In examples, the WTRU may perform measurements on a neighboring cell and measurement reporting associated with (e.g., as a function of) a Rx-Tx time difference value for a t path (e.g., for each path of a number of path(s)).

As described herein, the WTRU may determine a propagation delay (PD) for a path (e.g., of a number of path(s)). The PD may be determined based on at least on one or more of the following: a timing of a received DL RS, a timing of a transmitted UL RS, and a received Rx-Tx time difference value. If the determined PD meets a threshold for the path (e.g., of a number of path(s)), the WTRU may apply a PDC to an UL transmission that uses the path (e.g., of a number of path(s)). The PDC may be based on the determined PD. In examples, the PDC applied to the UL transmission may be associated with a DRX cycle length or a DRX configuration. In examples, the determined PD may meet the threshold for the path if a PD value is above or below a threshold value. In examples, the PDC may include a first PDC value. The WTRU may determine the validity of the first PDC value based on if: a second PDC value is not received or calculated, the WTRU remains connected to the same TRP, or the WTRU remains within an area (e.g., the WTRU remains stationary or remains within a geo-fenced location).

The PDC may be performed over multiple paths. A WTRU may determine a PDC value associated with (e.g., as a function of) PD estimation performed over multiple paths (e.g., a set of associated paths). The WTRU may determine the set of multiple paths as a function of measurements (e.g., WTRU or gNB Rx-Tx time difference value, PDC) performed on one or more of the paths. In examples, the WTRU may group a set of paths together if the PDC values determined for paths (e.g., all the paths) in the group fall within a configured range. The WTRU may report, to the gNB, the grouping of paths for which a PD procedure (e.g., single PD procedure) or PDC value are used. The WTRU may be configured with sets of associated paths, possibly by signaling from another node (e.g., gNB or WTRU).

A WTRU may determine a main path within a set of paths. The WTRU may perform a PD procedure or PDIE on the main path within the set of paths. A PDC value determined from a PD procedure or a PDIE on a main path may be applicable for transmissions on a path (e.g., any path) within the set of transmission paths. A WTRU may perform a transmission on one or more paths, possibly from different sets of associated paths. The WTRU may select a path on which to perform a transmission as a function of a measurement obtained during a PD procedure or a PDIE on the paths or associated with (e.g., as a function of) PDC values or PDC validity. A WTRU may transmit on multiple paths to enable diversity. The selection of the multiple paths may be a function of the sets of paths each path belongs to, a measurement, a validity of PDC, or a transmission requirement.

A Rx-Tx time difference measurement report may include an index for at least one RS on which one of the time measurements is performed. In examples, an Rx-Tx time difference measurement report may include multiple sets of RSs or RS pairs and multiple associated Rx-Tx time difference values.

The Rx-Tx time difference report may include multiple values (e.g., for multiple paths). The report may include a RS index or RS pair index associated with a value (e.g., each value). In examples, a single or group index may be associated with a set of Rx-Tx time difference measurement values. The single or group index may point to a set of paths associated with the multiple measurement values.

A WTRU may transmit or receive a Rx-Tx time difference measurement report for multiple RS pairs. The multiple RS pairs may be determined as multiple (e.g., all) combinations of at least one configured UL RS and one configured DL RS. In examples, there may be two UL RSs and two DL RSs. The Rx-Tx time difference measurement report may include Rx-Tx time difference measurements for combinations (e.g., all four combinations) of UL and DL RSs (e.g., or all four possible RS pairs).

As described herein, a WTRU may determine a PD for a path based on at least a timing of the received DL RS, a timing of the transmitted UL RS, and a received Rx-Tx time difference value. In examples, the WTRU may determine a PD by combining a WTRU Rx-Tx time difference measurement with a gNB Rx-Tx time difference measurement if the measurements are for the same UL RS and DL RS or RS pairs, or for the same UL RS occasion, DL RS occasion, or RS pair occasions. In examples, a WTRU may combine a WTRU Rx-Tx time difference measurement with a gNB Rx-Tx time difference if at least one of the following is satisfied: the RS or RS occasion used by the WTRU for the Tx timing is the same as, QCL with, or associated by a spatial relationship with the RS or RS occasion used by the gNB for Rx timing; the RS or RS occasion used by the WTRU for the Rx timing is the same as, QCL with, or associated by spatial relationship with the RS or RS occasion used by the gNB for Tx timing; or the RS pair or RS pair occasion used by the WTRU is the same as, QCL with, or associated by spatial relationship with the RS pair or RS pair occasion used by the gNB.

A WTRU may maintain multiple PD procedures and possibly multiple PDC values (e.g., one per path). A PD procedure or PDC value (e.g., each PD or PDC value) may be identified with an index. The index may be a PDC procedure specific index, or the index may be determined by at least one of the associated RS indices.

A WTRU may operate on multiple carriers. The WTRU may be configured to perform or estimate PDC on a subset of at least one of an UL or a DL component carrier, herein referred to as “PDC computation carriers.” The WTRU may use PDC estimates from one or more PDC computation carriers to apply for other active component carriers, herein referred to as “PDC dependent carriers.” A carrier may be at least one of a PDC computation carrier or a PDC dependent carrier. The WTRU may be configured by higher layer signaling (e.g., RRC) or may be indicated (e.g., using a MAC CE) with a mapping or association between a PDC dependent carrier and an associated PDC computation carrier. The WTRU may assume that component carriers (e.g., all component carriers) within the same TA group (TAG) have the same PDC. The WTRU may compute a PDC based one or more carriers in the same TAG or PDC computation carriers. The WTRU may receive dynamic signaling (e.g., MAC CE or DCI) indicating which carriers are associated or which carriers should be part of the PDC computation carriers or the TAG. In examples, a DL carrier may be a PDC computation carrier, while an UL carrier may be a PDC dependent carrier.

The WTRU may determine which carriers are part of the PDC computation carriers set and the PDC dependent carriers set dynamically (e.g., based on estimation of the Rx-Tx time difference between carriers or based on channel conditions). In examples, from a set of carriers configured or valid for a PDC, the WTRU may estimate the Rx-Tx time difference per at least one of a UL or a DL carrier; and the WTRU may associate carriers that have their Rx-Tx time difference within a predefined or configured range. The WTRU may associate carriers that have the same timing advance value, TAG, or if their TA difference is not more than a certain configured or predefined threshold. The WTRU may include a carrier in the PDC computation carriers set or the PDC dependent carriers set if a channel measurement associated with the carrier is within a predefined or configured threshold (e.g., RSRP>threshold). The WTRU may include a carrier in the PDC computation carriers set or the PDC dependent carriers set if the associated timing advance is within a configured or predefined range. The WTRU may consider carriers (e.g., all carriers) that belong to the same sidelink as PDC dependent carriers.

The WTRU may report or indicate the sets of PDC computation carriers and PDC dependent carriers to the gNB (e.g., for DL component carriers using an UL MAC CE). The gNB may indicate the sets of PDC computation carriers and PDC dependent carriers to the WTRU (e.g., for UL component carriers using a DL MAC CE). The WTRU may be configured with a period over which the WTRU may report the PDC carrier sets at least once (e.g., the WTRU reports the sets after expiration of a prohibit timer). A report for a PD information exchange may include the set of carriers for which the PD information exchange is applicable.

The WTRU may compute and estimate a PDC per PDC computation carrier. The WTRU may use UL resources on a DL carrier to transmit an UL RS that may enable the gNB to compute PDC. The WTRU may use DL resources on an UL carrier to receive a DL RS to estimate a PDC.

The WTRU may compute an aggregate PDC value for a number of associated carriers. The WTRU may estimate a PDC value from a number of associated PDC computation carriers and apply it for these carriers and their PDC dependent carriers. For a dependent carrier, the WTRU may adjust a PDC value computed from an associated PDC computation carrier based on the difference of subcarrier spacing or center frequency. The WTRU may use a PDC value received from the gNB to estimate PDC on an associated UL carrier.

As described herein, the WTRU may be configured with a period for which a PDC value (e.g., a first PDC value) obtained from a different computation carrier is valid for. If the period expires, the WTRU may obtain another PDC value (e.g., a second PDC value) or consider the carrier a computation carrier. The WTRU may trigger a PDC or a PD information exchange for one carrier, one set of carriers, or all carriers, after at least one of the following conditions: an expiration of a configured timer; a determination of clock drift from a different PDC source (e.g., sidelink or a different PDC computation carrier); the clock drift being more than a predetermined or configured threshold; a measurement of channel conditions being less than a configured or predestined threshold or within a range; the expiration of a TA timer for the cell; the WTRU determines that the PDC value for an associated carrier is off by a difference larger than a configured or predetermined threshold; or the WTRU receives a TA command for the cell or the TAG for which the cell belongs.

Examples of handling mobility are provided herein. A WTRU may perform PDC, acquire an updated PDC, or trigger a PDC information exchange based on WTRU mobility (e.g., based on successful triggering of conditional handover or reception of a handover command).

The WTRU may perform measurements on neighboring cells and measurement reporting associated with (e.g., as a function of) the Rx-Tx time difference value. The Rx-Tx time value-based trigger may be associated with (e.g., may be a function of) the WTRU and serving cell, the WTRU and neighboring cell, or a combination of the two. Possible triggering conditions to start performing measurements on a neighboring cell, stop performing measurements on a neighboring cell, or transmit a measurement report may be at least one of the following: a WTRU-serving cell Rx-Tx time difference exceeding a threshold; a WTRU-serving cell Rx-Tx time difference falling below a threshold; a WTRU-neighboring cell Rx-Tx time difference exceeding a threshold; a WTRU-neighboring cell Rx-Tx time difference falling below a threshold; a WTRU-neighboring cell Rx-Tx time difference exceeding WTRU-serving cell Rx-Tx time difference; a WTRU-neighboring cell Rx-Tx time difference falling below WTRU-serving cell Rx-Tx time difference; or a WTRU-neighboring cell Rx-Tx time difference falling below WTRU-serving cell Rx-Tx time difference by a configured threshold.

A WTRU may be configured to transmit a RS in an UL transmission when performing measurements on a neighbor cell. A WTRU may be configured with triggering events (e.g., one or more of the above triggering events) as a conditional handover triggering conditions. The triggering conditions (e.g., the above triggering conditions) may be combined with one or more additional triggering conditions such as RSRP-based triggers, time-based triggers, or location-based triggers. If a conditional handover is executed, the WTRU may request or execute a PD information exchange procedure.

Examples of DRX-state based PDC acquisition are provided herein. The WTRU may perform PDC, use a previously acquired PDC value, update a stored PDC value, or perform a PD information exchange depending on DRX state (e.g., whether the WTRU is in DRX active time, whether the DRX time (e.g., via the onDuration timer) is running, or if the WTRU is in DRX sleep). In examples, the WTRU may reuse a previously acquired PDC value for an upcoming onDuration, perform PDC or acquire another PDC value at every DRX-on Duration, or perform PDC or acquire another PDC value if the WTRU is addressed via a PDCCH in an OnDuration.

The WTRU may perform a PDC update or information exchange associated with (e.g., as a function) of the DRX cycle length or DRX configuration. In examples, a WTRU in a long DRX cycle may perform a PDC update or information exchange every DRX onDuration, whereas a WTRU in a DRX short cycle may perform a PDC update or information exchange every N DRX onDurations (e.g., where N may be a configured value greater or equal to 2). If a PDC value is acquired, the WTRU may assume that a PDC value is valid (e.g., remains valid) while the WTRU is in DRX active time (e.g., remains in DRX active time), possibly in combination with other validity criteria described herein.

Examples of PDC assistance information to select a DRX configuration are provided herein. The WTRU may provide a DRX configuration preference indication based on PDC requirements. The DRX configuration preference indication may include the WTRU requesting a DRX configuration or set of DRX configurations which enables the WTRU to maintain a valid PDC value. The WTRU may report WTRU characteristics (e.g., a currently used PDC value, a stationarity property, a device type, WTRU speed, WTRU position information, the WTRU mobility state estimation, whether the WTRU is performing PDC, the WTRU estimate of path delay) to help the network determine an acceptable DRX configuration.

Examples of a PDC and a wake-up signal indication are provided herein. A WTRU may determine that a PDC value is satisfactory based on a wake-up signal. The WTRU may receive information regarding the applicability of the PDC value within the wakeup signal (e.g., via DCI) or may observe a time delay with a sequence-based wake-up signal. The WTRU may use this determination to perform a PDC information exchange to update the PDC value. The WTRU may apply a PDC value estimation based on the wake-up signal to monitor the following DRX on-duration.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), comprising:
a processor configured to:
receive configuration information identifying a reference signal (RS) pair associated with a path;
determine that a trigger condition associated with the path is satisfied;
receive a downlink (DL) RS associated with the path and transmit an uplink (UL) RS associated with the path, wherein the DL RS and the UL RS are associated with the RS pair;
receive, from a base station, a Rx-Tx time difference value for the path;
determine a propagation delay (PD) for the path based on: a timing of the received DL RS, a timing of the transmitted UL RS, and the received Rx-Tx time difference value; and
based on the determined PD meeting a threshold for the path, apply a propagation delay compensation (PDC) to a UL transmission associated with the path, wherein the PDC is based on the determined PD.

17. The WTRU of claim 16, wherein the path is associated with at least one of: a bandwidth part (BWP), a carrier, a transmission/reception point (TRP), a cell, a beam, a transmission configuration indication (TCI) state, or a link type.

18. The WTRU of claim 16, wherein the trigger condition is associated with at least one of: a parameter of the path being changed, a PDC validity time expiring, or a PDC failure occurring.

19. The WTRU of claim 16, wherein the trigger condition is associated with at least one of: a random access (RA) procedure; a BWP or a subcarrier spacing (SCS) change; a reception of a signal associated with a propagation delay information exchange (PDIE); a UL listen before talk (LBT) failure detection; beam switching; a UL transmission type or UL transmission priority; a location and speed of the WTRU; a cross-layer indication; a request from the WTRU; radio link failure (RLF); or a hybrid automatic repeat request (HARQ) ACK feedback.

20. The WTRU of claim 16, wherein the determined PD meets the threshold for the path based on a PD value being above or below a threshold value.

21. The WTRU of claim 16, wherein the PDC comprises a first PDC value, and the first PDC value is determined to be valid if: a second PDC value is not received or calculated; the WTRU remains connected to a TRP; the WTRU remains stationary; or the WTRU remains within an area.

22. The WTRU of claim 16, wherein the processor is further configured to perform measurements on a neighboring cell and measurement reporting as a function of the Rx-Tx time difference value.

23. The WTRU of claim 16, wherein the PDC is applied to the UL transmission associated with a discontinuous reception (DRX) cycle length or a DRX configuration.

24. A method performed by a wireless transmit/receive unit (WTRU), comprising:
receiving configuration information identifying a reference signal (RS) pair associated with a path;
determining that a trigger condition associated with the path is satisfied;
receiving a downlink (DL) RS associated with the path and transmit an uplink (UL) RS associated with the path, wherein the DL RS and the UL RS are associated with the RS pair;
receiving, from a base station, a Rx-Tx time difference value for the path;
determining a propagation delay (PD) for the based on: a timing of the received DL RS, a timing of the transmitted UL RS, and the received Rx-Tx time difference value; and
based on the determined PD meeting a threshold for the path, applying a propagation delay compensation (PDC) to a UL transmission associated with the path, wherein the PDC is based on the determined PD.

25. The method of claim 24, wherein the path is associated with at least one of: a bandwidth part (BWP), a carrier, a transmission/reception point (TRP), a cell, a beam, a transmission configuration indication (TCI) state, or a link type.

26. The method of claim 24, wherein the trigger condition is associated with at least one of: a parameter of at least one of the paths being changed, a PDC validity time expiring, or a PDC failure occurring.

27. The method of claim 24, wherein the trigger condition is associated with at least one of: a random access (RA) procedure; a BWP or a subcarrier spacing (SCS) change; a reception of a signal associated with a propagation delay information exchange (PDIE); a UL listen before talk (LBT) failure detection; beam switching; a UL transmission type or UL transmission priority; a location and speed of the WTRU; a cross-layer indication; a request from the WTRU; radio link failure (RLF); or a hybrid automatic repeat request (HARQ) ACK feedback.

28. The method of claim 24, wherein the determined PD meets the threshold for the path if a PD value is above or below a threshold value.

29. The method of claim 24, wherein the PDC comprises a first PDC value, and the first PDC value is determined to be valid if: a second PDC value is not received or calculated; the WTRU remains connected to a TRP; the WTRU remains stationary; or the WTRU remains within an area.

30. The method of claim 24, further comprising:
performing measurements on a neighboring cell and measurement reporting as a function of the respective Rx-Tx time difference value.

31. The method of claim 24, wherein the PDC is applied to the UL transmission associated with a discontinuous reception (DRX) cycle length or a DRX configuration.
